(19) United States
(12) Patent Application Publication
(10) Pub. No.: US 2006/0205550 A1
(43) Pub. Date: Sep. 14, 2006

(54) Link chain and associated methods

(76) Inventors: Byron Anderson, Austin, TX (US); Ronald J. Bonner, Maitland, FL (US)

Correspondence Address: JACQUELINE E. HARTT, PH.D;ALLEN, DYER, DOPPELT, MILBRATH & GILCHRIST, P.A., P.O. BOX 3791, ORLANDO, FL, 32802-3791, US

(21) Appl. No.: 11/367,746

(22) Filed: Mar. 3, 2006

Related U.S. Application Data
(63) Continuation-in-part of application No. 10/855,881, filed on May 27, 2004.
(60) Provisional application No. 60/658,497, filed on Mar. 4, 2005.

(51) Int. Cl. F16G 13/02

(52) U.S. Cl. 474/234; 474/230; 474/219

(57) ABSTRACT

A bicycle chain for improved endurance includes pairs of substantially identical plates. Each plate has a generally oval shape, with, in one embodiment, a generally centrally located indentation along an inner edge. A pair of plates is orientable with the respective inner faces of the first and the second end portions parallel and opposed. A spacing between inner faces of the first end portions is thereby less than a spacing between the inner faces of the second end portions. A pivot pin extends through the second end portion hole of a first plate through a first end portion hole of a third plate, through a spacer body, through a first end portion hole of a fourth plate, and through the second end portion hole of the second plate, the pivot pin rotatably anchored adjacent the outer faces of the first and the second plates.

### CROSS-REFERENCE TO RELATED APPLICATION

This application claims priority to provisional application Ser. No. 60/658,497, filed Mar. 4, 2006, entitled “Link Chain and Associated Methods,” and is a continuation-in-part and application Ser. No. 10/855,881, filed May 27, 2004, entitled “Link Chain and Associated Methods.”

### BACKGROUND OF THE INVENTION

1. Field of the Invention

The present invention relates to link chains, and, more particularly, to bicycle chains, and, even more particularly, for use in high-performance bicycle riding situations.

2. Description of Related Art

Bicycle chains such as that illustrated in FIGS. 1 and 2 are known in the art. In this type of chain 60, each link is formed from a spacer body 61 sandwiched between two substantially identical, barbell-shaped plates 62,63, joined by a pin 64 extending through bores in these elements 61-63 and flattened at each end to restrain the elements together. These plates 62,63 are generally barbell-shaped, with each lobe substantially identical. A chain 60 is formed by assembling a sequence of links wherein a first plate 62 is positioned atop both adjacent second links 63.

These chains have been used on bicycles and generally have performed adequately. However, with the advent of “extreme” sports, bicycles have been used in increasingly acrobatic maneuvers, which places considerably more strain on the chain than previously experienced. In “freestyling” maneuvers, for example, in which the bicycle chain may be run along a cement or steel surface, prior art chains have been known to be subject to breakage, an obviously dangerous eventuality. A particular known type of breakage includes a plate, typically an outer, first plate, disengaging from its link.

Another difficulty with prior art chains is that, if additional length is needed, a “half-length” is added with a cotter pin, which reduces the robustness of the chain; if less length is needed, two links must be removed, which subtracts approximately 1 in. from the chain length.

Therefore, it would be desirable to provide a bicycle chain that can endure more strenuous conditions than previously experienced. It would also be desirable to provide a chain the length of which is more finely adjustable.

### SUMMARY OF THE INVENTION

A link chain for improved endurance under stress of the present invention comprises a plurality of pairs of substantially identical plates. Each plate has a generally oval shape. In one embodiment, the plate has a generally centrally located indentation along an inner edge. Each plate further has a first substantially planar end portion and an opposed, substantially planar, second end portion. The first and the second end portion are joined by an outwardly stepped portion. Each of the first and the second end portions have a hole therethrough from an outer face through to an inner face. A pair of plates is orientable with the respective inner faces of the first and the second end portions parallel and opposed. A spacing between inner faces of the first end portions is thereby less than a spacing between the inner faces of the second end portions.

Also provided is a pivot pin. The pivot pin extends through the second end portion hole of a first plate, through the first end portion hole of a third plate, through a first end portion hole of a fourth plate, and through the second end portion hole of a second plate, the pivot pin rotatably anchored at opposed ends adjacent the outer faces of the first and the second plates.

An elongated chain is made by continuing the above construction linearly to a desired length. In an exemplary embodiment, the chain of the present invention comprises a bicycle chain, although this is not intended as a limitation, and the chain may also be contemplated for use in situations such as assembly lines.

Laboratory testing of the chain of the present invention has shown that the tensile strength is at least twice that of a prior art bicycle chain, and the pin strength, five times.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 (prior art) is a top plan view of a section of a prior art bicycle chain.

FIG. 2 (prior art) is a side view of the bicycle chain section of FIG. 1.

FIG. 3 is a top plan view of a section of the chain of the present invention.

FIG. 4 is a side view of the chain section of FIG. 3.

FIG. 5 is a side view of another embodiment of a plate.

FIG. 6 is a side perspective view of a chain on a cog.

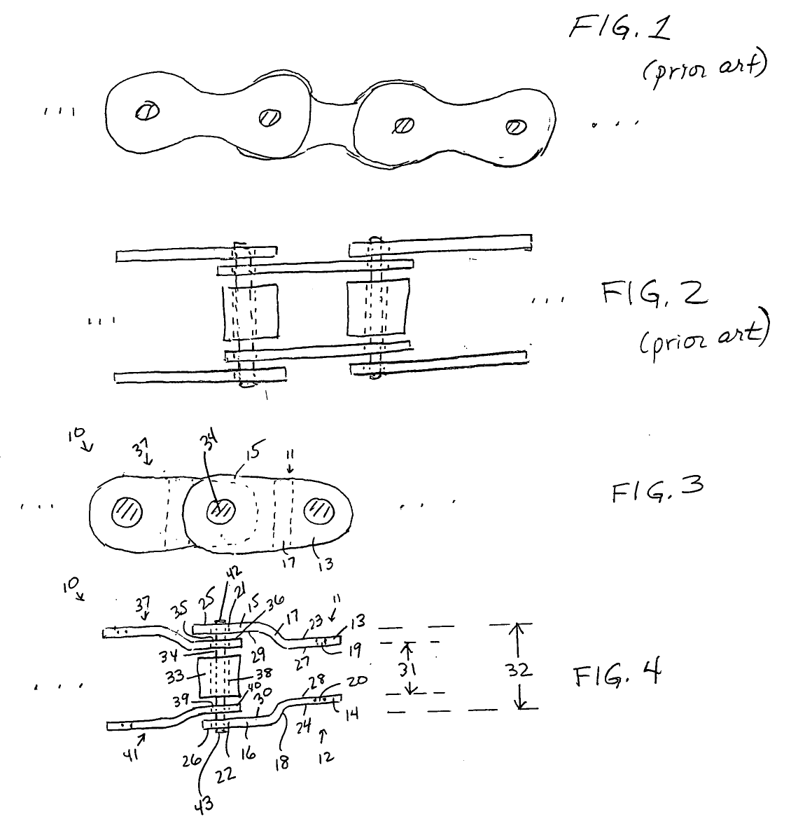

### DETAILED DESCRIPTION OF THE PREFERRED EMBODIMENTS

A description of the preferred embodiments of the present invention will now be presented with reference to FIGS. 3-6.

A chain 10, for example, a bicycle chain, for improved endurance under stress of the present invention comprises a plurality of pairs of substantially identical plates 11,12. Each plate 11,12, has a generally oval shape. In another embodiment, illustrated in FIG. 5, a plate 11′ has a generally oval shape as well, but has a generally centrally located indentation 110 along an inner edge 111. This embodiment has been found to be useful for applications wherein a smaller-circumference sprocket is used. In the past, bicycle chains that have been used with cogs greater than 10 teeth have been known to be subject to excessive stress, leading to chain breakage. Further, the chain 10 using plates 11,12 did not fit on a 9-tooth cog. However, in the alternate embodiment of FIG. 5, the indentation 110 on the plate 11′ enables a smaller sprocket to be used, such as, for example, a 9-tooth cog.

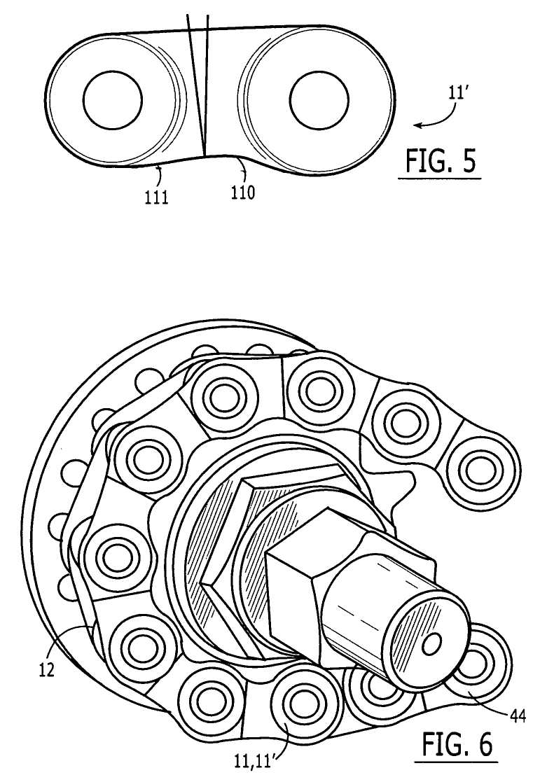

Returning to the initial embodiment of FIGS. 3 and 4, each plate 11,12 also has a first substantially planar end portion 13,14 and an opposed, substantially planar, second end portion 15,16. The first 13,14 and the second 15,16 end portions are joined by an outwardly stepped portion 17,18. Each of the first 13,14 and the second 15,16 end portions have a hole 19-22 therethrough from an outer face 23-26 through to an inner face 27-30. A pair of plates 11,12 is orientable with the respective inner faces 27,28;29,30 of the first 13,14 and the second 15,16 end portions parallel and opposed. A spacing 31 between inner faces 27,28 of the first end portions 13,14 is thereby less than a spacing 32 between the inner faces 29,30 of the second end portions 15,16.

Also provided are a generally cylindrical spacer body 33 and a pivot pin 34. The pivot pin 34 extends through the second end portion hole 21 from the outer face 25 of the first plate second end portion 15, through a first end portion hole 35 from an outer face 36 of a third plate 37, through a bore 38 through the spacer body 33, through a first end portion hole 39 from an inner face 40 of a fourth plate 41, and through the second end portion hole 22 from the inner face 30 of the second plate 12. The pivot pin 34 is rotatably anchored at opposed ends 42,43 adjacent the outer faces 25,26 of the first 11 and the second 12 plates.

An elongated chain 44 is made by continuing the above constructions linearly to a desired length. See, for example, FIG. 6.

The chain 10 made according to the present invention has been found to be more adjustable than prior art chains, as well as being stronger and adaptable to a greater range of cog sizes.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

What is claimed is:

1. A chain link for improved endurance under stress comprising:
a plurality of pairs of substantially identical plates, each plate having a generally oval shape with a generally centrally located indentation along an inner edge, each plate further having a first substantially planar end portion and an opposed, substantially planar, second end portion, the first and the second end portion joined by an outwardly stepped portion, each of the first and the second end portions having a hole therethrough from an outer face through to an inner face, a pair of plates orientable with the respective inner faces of the first and the second end portions parallel and opposed, a spacing between the inner faces of the first end portions thereby less than a spacing between the inner faces of the second end portions; and
a plurality of pivot pins, each pin extending through the second end portion hole of a first plate, through the first end portion hole of a third plate, through the first end portion hole of a fourth plate, and through the second end portion hole of a second plate, the pivot pin rotatably anchored at opposed ends adjacent the outer faces of the first and the second plates.

2. The chain recited in claim 1, further comprising a generally cylindrical spacer body having a bore therethrough, the spacer positioned between the inner faces of the third and the fourth plates.

3. The chain recited in claim 1, wherein each pivot pin has an enlarged portion at each of the opposed ends, the enlarged portions sufficiently large to prevent movement of the enlarged portions through the first plate second end portion hole and the second plate second end portion hole.

4. The chain recited in claim 1, wherein the chain is adapted for placement and use on a bicycle.

5. A method of improving the safety of riding a bicycle comprising the steps of:
providing a bicycle chain comprising:
a plurality of pairs of substantially identical plates, each plate having a generally oval shape with a generally centrally located indentation along an inner edge, each plate further having a first substantially planar end portion and an opposed, substantially planar, second end portion, the first and the second end portion joined by an outwardly stepped portion, each of the first and the second end portions having a hole therethrough from an outer face through to an inner face, a pair of plates orientable with the respective inner faces of the first and the second end portions parallel and opposed, a spacing between the inner faces of the first end portions thereby less than a spacing between the inner faces of the second end portions; and
a pivot pin extending through the second end portion hole of a first plate, through the first end portion hole of a third plate, through the first end portion hole of a fourth plate, and through the second end portion hole of a second plate, the pivot pin rotatably anchored at opposed ends adjacent the outer faces of the first and the second plates; and
placing the bicycle chain on a bicycle.

6. The method recited in claim 5, wherein the bicycle chain further comprises a generally cylindrical spacer body having a bore therethrough, the spacer positioned between the inner faces of the third and the fourth plates.

7. The method recited in claim 5, wherein the pivot pin has an enlarged portion at each of the opposed ends, the enlarged portions sufficiently large to prevent movement of the enlarged portions through the first plate second end portion hole and the second plate second end portion hole.
